(19) United States
(12) Patent Application Publication
(10) Pub. No.: US 2011/0162739 A1
(43) Pub. Date: Jul. 7, 2011

(54) BLOCK ASSEMBLY FOR PNEUMATIC DISTRIBUTORS

(76) Inventors: Marcus Mead, Cornwall (GB); David Bourdier, Gravigny (FR)

(21) Appl. No.: 12/301,818

(22) PCT Filed: May 23, 2007
(86) PCT No.: PCT/FR2007/000864

§ 371 Date: Nov. 21, 2008

(30) Foreign Application Priority Data
Jun. 2, 2006 (FR) 0604931

(51) Int. Cl. F15D 1/00

(52) U.S. Cl. 137/597

(57) ABSTRACT

The present invention relates to a block assembly (15) for pneumatic distributors (1) comprising a base (16) intended to receive a plurality of pneumatic distributors, possessing for this purpose at least one supply duct which can be connected to a supply inlet of each distributor and at least one exhaust duct which can be connected to each exhaust outlet of each distributor, and additionally having. for each control outlet of each distributor, at least one corresponding outlet channel intended to be connected to a pneumatic actuator, said base being designed such that the pneumatic distributors can be arranged on either side of a longitudinal central axis (A) of said base in at least two substantially parallel rows, characterized in that the base is also designed to equally receive pneumatic distributors of different types.

The present invention relates to a block assembly for pneumatic distributors.

A pneumatic distributor is a pre-actuator which distributes pneumatic energy to a pneumatic actuator, typically a jack, so as to control it according to a control instruction that it receives.

The pneumatic distributors are an integral part of the action subsystem which makes it possible, from a control instruction, to distribute the pneumatic energy to the jacks of a machine, and there is generally one distributor for each jack to be controlled.

A pneumatic distributor comprises a body with several orifices and comprising a drawer which can assume several positions enabling a different communication circuit between the orifices depending on the selected position.

For example, in the case of controlling a dual-acting jack, that is, one comprising a pressure chamber either side of the piston connected to the rod of the jack, it is possible to use a so-called 5/2 pneumatic distributor, namely a distributor that has five orifices and two functions or cells implemented by a drawer that can assume two positions each corresponding to a particular communication scheme.

Among the five orifices, there is a compressed air supply orifice, an outlet orifice towards each chamber of the jack and two exhaust orifices generally located on either side of the compressed air intake orifice.

The drawer is designed so as to be able to assume two positions, namely a first position in which the orifice corresponding to the rear chamber is in communication with the compressed air intake orifice and in which the orifice corresponding to the front chamber is in communication with an exhaust orifice, which, because of this, enables the rod of the jack to be extended; and a second position in which the orifice corresponding to the rear chamber is in communication with an exhaust orifice and in which the orifice corresponding to the front chamber is in communication with the compressed air intake orifice, because of this provoking the retraction of the jack rod.

There are also so-called 4/2 pneumatic distributors which have only a single exhaust orifice and so-called 3/2 pneumatic distributors intended to control single-acting jacks and comprising only one exhaust orifice and one control orifice in addition to the compressed air intake orifice.

Generally, the set of pneumatic distributors controlling a set of jacks is combined on a block assembly for pneumatic distributors by stacking along a longitudinal axis of the block assembly. Such a configuration is advantageous because it makes it possible to combine the compressed air supply and the exhaust outlets via a common base. It also makes it possible to centralize the electronic control of the pneumatic distributors and combine them in a block that can easily be isolated from any aggressive workshop conditions.

A block assembly for distributors can, depending on the application, comprise between 8 and 32, even up to 64, pneumatic distributors.

Although it has many advantages, the grouping of distributors on a block assembly presents one major drawback, namely bulk.

In practice, with pneumatic distributors that have an average width of approximately 20 to 25 mm, a block assembly for 32 distributors has a minimum length of 64 cm. Such lengths can easily become an obstacle to an installation on a machine or in a control cabinet.

To resolve this problem, various manufacturers have naturally sought to reduce the width of a pneumatic distributor and have succeeded in producing distributors with a unit width of 10, and even 8, mm.

However, a fundamental aspect of a pneumatic distributor is the ability to allow a sufficient flow rate of compressed air to pass to ensure a good responsiveness of the jack to a given control. The reduction of the width of a distributor has therefore been accompanied by an increase in its length so as to be able to have a switching volume, and therefore a flow rate passage capacity, that is substantially equivalent. For example, the market offers distributors having a width of 10.5 mm with a length of 110 mm, whereas a distributor of standard size conventionally has a width of 20 to 25 mm with a length of approximately 60 mm.

It will, however, be noted that the reduction of the width is also accompanied by a reduction of the diameters of the compressed air passage ducts, which leads to greater head losses and provokes a degradation of performance even with a substantially equivalent switching volume.

This increase in the length of a pneumatic distributor is also reflected in a higher response time, an increase in the operating threshold of the drawer and sticking problems. In practice, the drawer is fitted with nitrile seals in order to ensure optimum communication of the compressed air with no loss of pressure. Because of the reduction in the width of the distributor and the miniaturization of all of its component elements, the seals must provide a perfect seal-tightness. Because of this, the frictions that they undergo when the drawer is displaced are greater and therefore lead to an increase in the force needed to displace the drawer and more rapid wear of these seals.

One solution to this problem is to have the pneumatic distributors on either side of a longitudinal central axis of the distributor in at least two substantially parallel rows.

Thus, by associating the pneumatic distributors on either side of a longitudinal central axis of the base, unlike the state of the art in which thinner pneumatic distributors follow each other along said central axis, it is possible to use pneumatic distributors that have standard dimensions and proven effectiveness to produce a block assembly for distributors having a width for each distributor equivalent to, or even less than, the unit width of the narrow distributors of the state of the art. For example, in the case of a prior art using unit pneumatic distributors 10.5 mm wide and 110 mm long, a block assembly according to the invention can use standard distributors 20 mm wide and 60 mm long. For the prior art, a block of two distributors will therefore be 21 mm wide and 110 mm long whereas according to the invention a block of two distributors is obtained that has a width of 20 mm and a length of 120 mm, or, ultimately, an equivalent width for each distributor of 10 mm for a substantially equal length.

Since the pneumatic distributors that are used are standard, additional machining and seal costs are avoided, as are reliability problems and the other problems stated previously.

Moreover, the invention thus proposes an alternative solution for reducing the overall length of a block assembly for pneumatic distributors of standard size by transferring a part of the bulk lengthwise of the block assembly to its width.

Examples of such arrangements can be found in the documents WO02/38966 and US2004/089352.

Another solution for overcoming the sticking problems is to produce a seal-less switching. To do this, and to minimize the leaks, it is necessary to very accurately pair the pieces with each other in order to ensure the most perfect possible alignment between the drawer and the compressed air circulation ducts. Producing seal-less switching requires very fine and very precise machining of the parts, which is particularly costly.

The aim of the present invention is to overcome the drawbacks stated previously, and, for this, consists of a block assembly for pneumatic distributors comprising a base intended to receive a plurality of pneumatic distributors, possessing for this purpose at least one supply duct which can be connected to a supply inlet of each distributor and at least one exhaust duct which can be linked to each exhaust outlet of each distributor, and additionally having, for each control outlet of each distributor, at least one corresponding outlet channel intended to be connected to a pneumatic actuator, substantially parallel, characterized in that the base is also designed to equally receive pneumatic distributors of different types.

Thus, thanks to the invention, it is possible to combine the types of distributors, for example by providing a row of 3/2 distributors and a row of 5/2 distributors, according to the actuators to be controlled.

In practice, the devices of the prior art are dedicated to only one type of pneumatic actuator and the solution is then to reproduce the operation of a more refined distributor (of 5/2 type) using the normal distributors (for example of 3/2 type) that it receives. This makes it possible to gain in functionality but also in number of distributors accommodated, since a distributor of 5/2 type requires two distributors of 3/2 type to reproduce all the functionalities thereof.

It is also possible to provide an arrangement of the various compressed air supply, control and exhaust ducts, such that the base can equally receive pneumatic distributors of 3/2, 5/2, 4/2 or other types.

Advantageously, the rows of pneumatic distributors are substantially juxtaposed.

Also advantageously, the pneumatic distributors can be arranged symmetrically relative to the longitudinal central axis.

Preferably, each pneumatic distributor comprises at least one actuation means which can be arranged facing an actuation means of the corresponding pneumatic distributor relative to the longitudinal central axis.

Advantageously, each pneumatic distributor comprises at least one actuation means and the base has at least one channel intended to receive at least one centralized means of electrically controlling the actuation means of at least one row of pneumatic distributors, of printed circuit type, said channel being able to allow a connection of the actuation means to the electrical control means.

Preferably, the base has a central channel intended to receive at least one centralized means of electrically controlling the actuation means of the pneumatic distributors.

Preferably, the base is designed to receive pneumatic distributors comprising pneumatic actuation means, of the solenoid valve type, and comprising at least one auxiliary supply duct under pressure and at least one auxiliary exhaust duct which can be connected to the actuation means.

Preferably again, the base is fitted with light guides, advantageously of plastic material, opening onto a face of the latter and which can guide a light signal emitted by the control means and representative of the position of the actuation means of the pneumatic distributor.

According to a first preferred embodiment, the outlet channels open out level with a front face or rear face of the base. It should be noted that “front face” is intended to mean a face seen first by the user when the block assembly is fixed in a cabinet. It is therefore a face substantially parallel to the longitudinal central axis.

According to a second preferred embodiment, the outlet channels open out level with a bottom face of the base. Since the space available is greater on the bottom face, it is then possible to provide connections, also standard, for the outlet channels. Moreover, such an arrangement makes it possible to isolate more easily the sensitive part of the distributor from the rest of the workshop and the connections.

According to a first embodiment variant, the base is designed to receive distributors of type 5/2.

According to a second embodiment variant, the base is designed to receive distributors of type 3/2.

Obviously, the types 5/2 and 3/2 are given by way of examples as the most widely used pneumatic distributors, but the distributors of type 5/3 and others can also be cited.

Advantageously, the base is produced from modules, each intended to receive at least one pair of pneumatic distributors. It is obviously possible to combine the modules together, for example by associating a two-distributor model and a four-distributor model to form a base of six pneumatic distributors.

The present invention also relates to an installation comprising at least one block assembly according to the invention in which are mounted the associated pneumatic distributors.

The implementation of the invention will be better understood from the detailed description which is explained hereinbelow in light of the appended drawing in which:

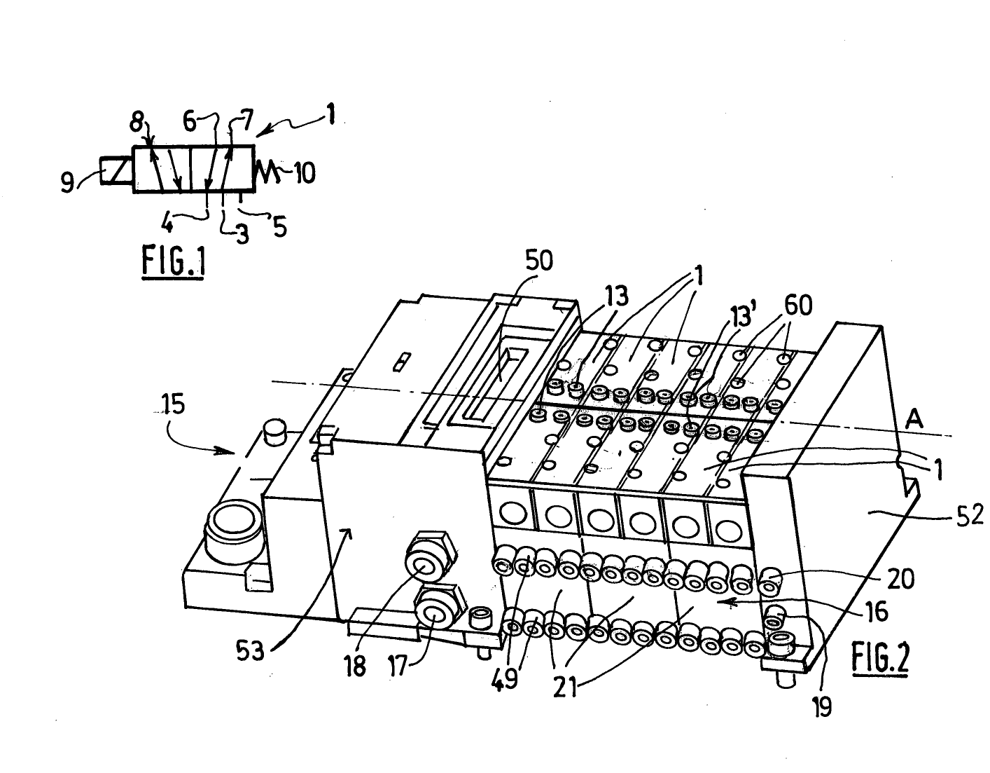

FIG. 1 is a functional diagrammatic representation of a pneumatic distributor of type 5/2.

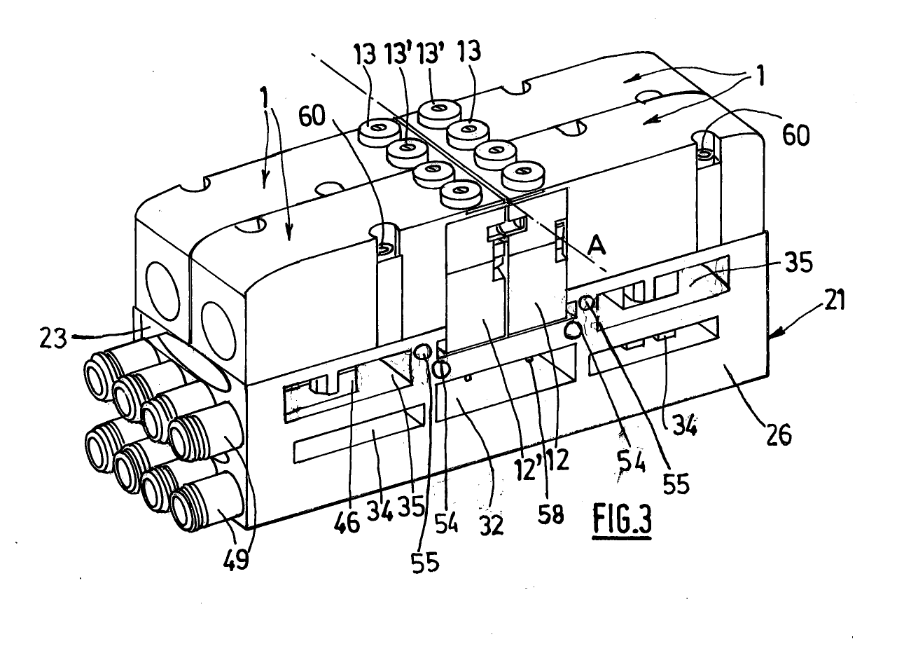

FIG. 2 is an overview of a first preferred embodiment of a block assembly for pneumatic distributors according to the invention.

FIG. 3 is a front perspective diagrammatic representation of a base module of the block assembly for pneumatic distributors of FIG. 2.

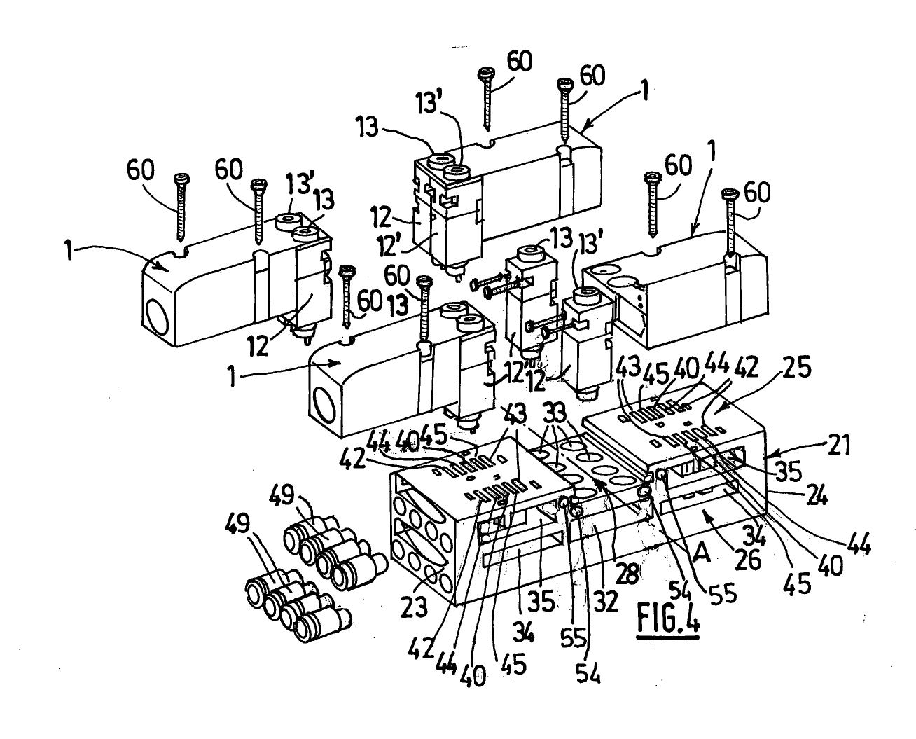

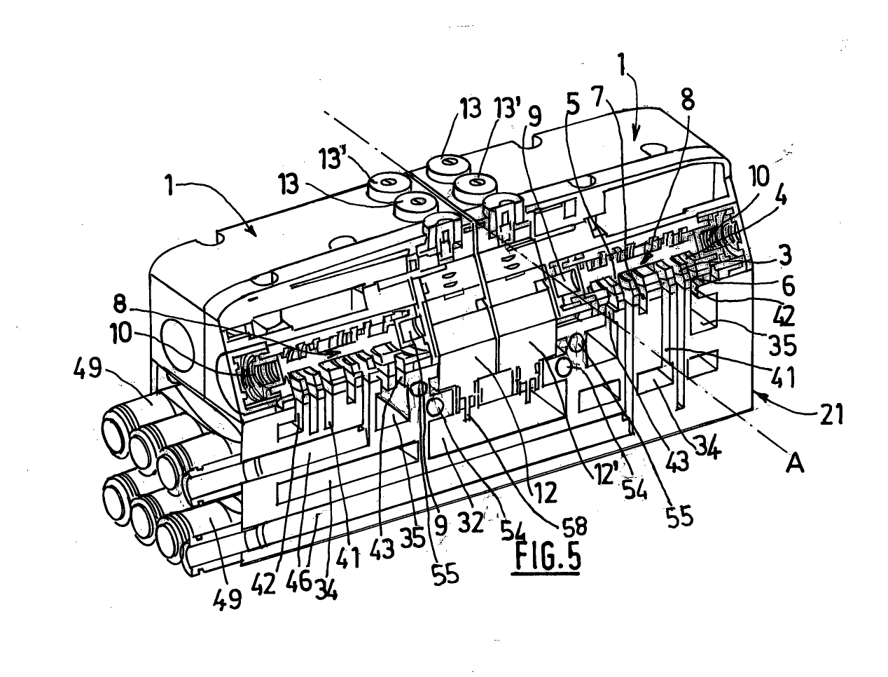

FIG. 4 is an exploded view of the module of FIG. 3.

FIG. 5 is a cross-sectional diagrammatic view of the module of FIG. 2 with a view of the interior of the pneumatic distributors.

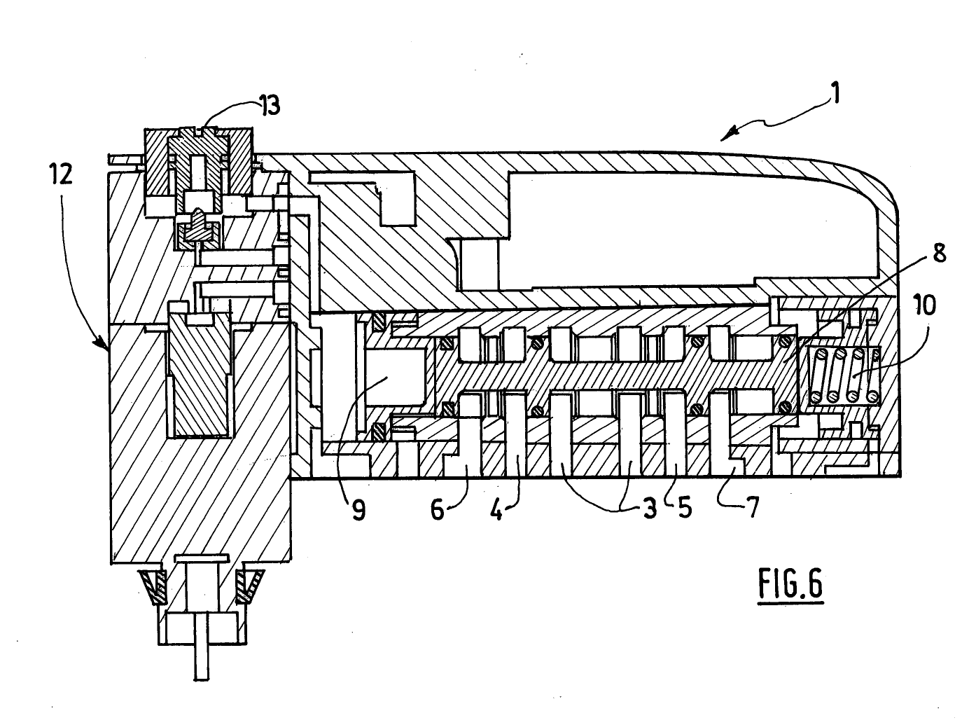

FIG. 6 is a longitudinal cross-sectional diagrammatic representation of a pneumatic distributor in a first operating position.

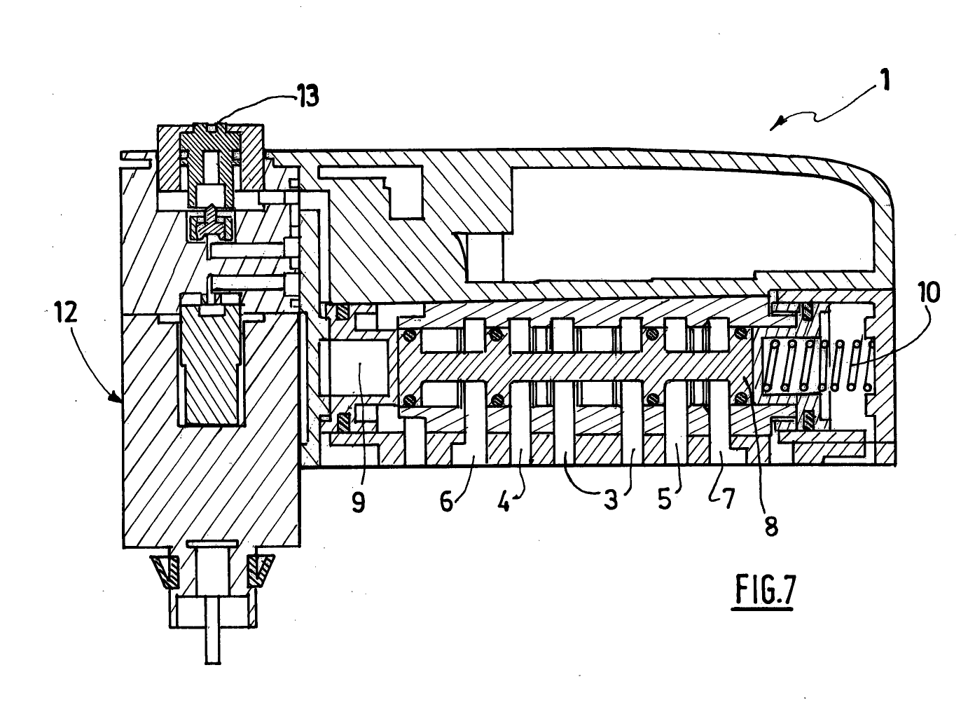

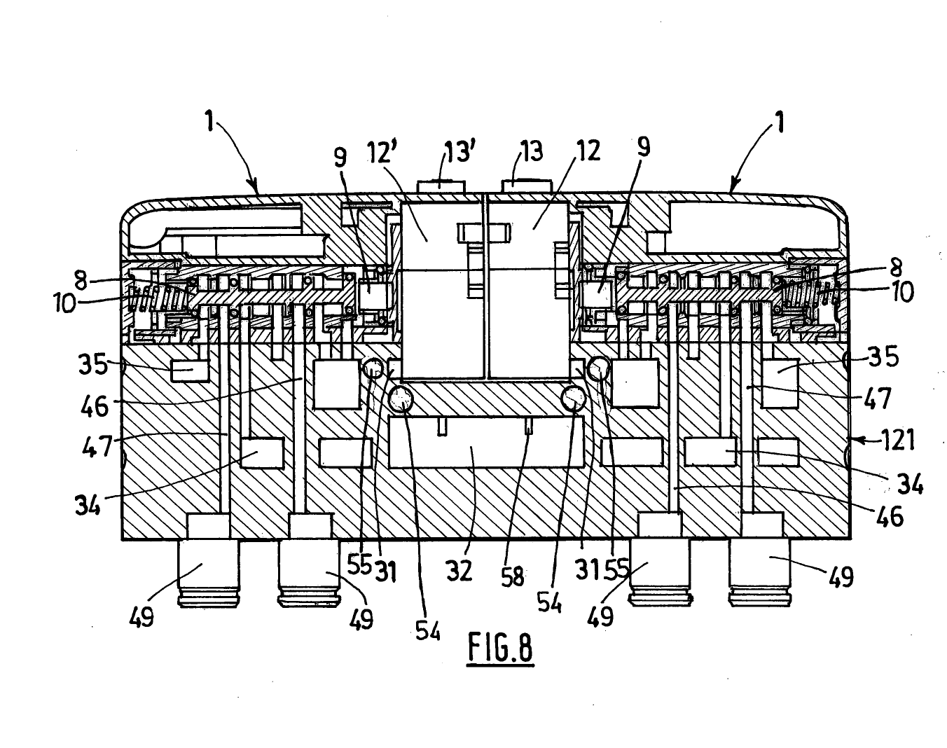

FIG. 7 is a longitudinal cross-sectional diagrammatic representation of the pneumatic distributor of FIG. 6 in a second operating position.

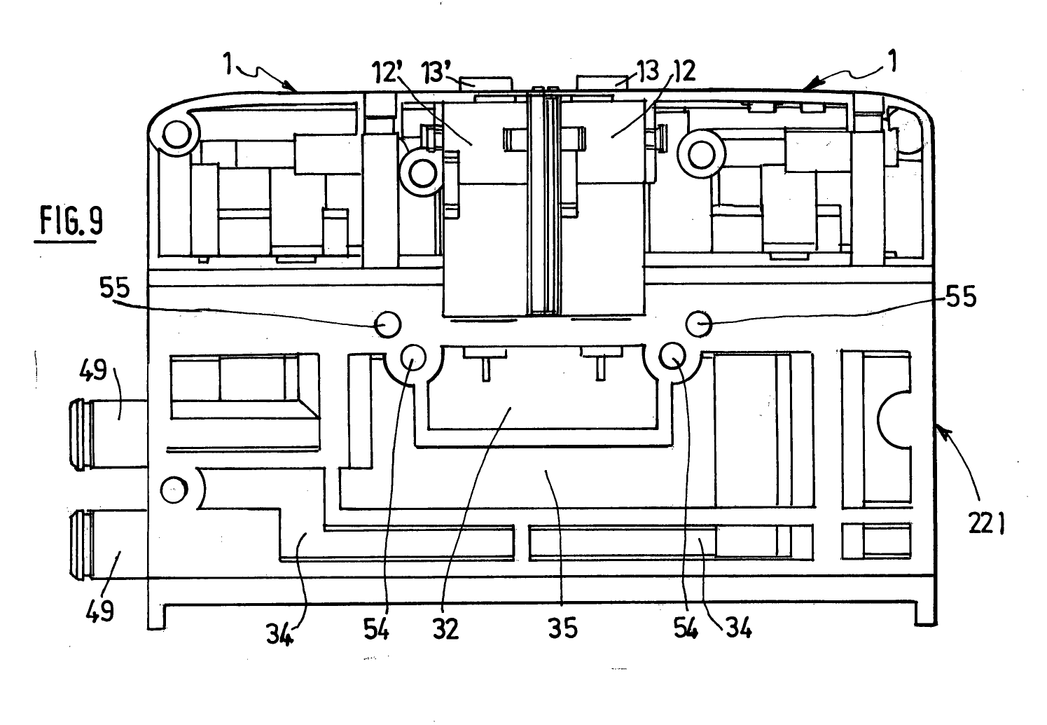

FIG. 8 is a cross-sectional diagrammatic view of a second embodiment of a block assembly for pneumatic distributors according to the invention having pneumatic outlets on a bottom face.

FIG. 9 is a transversal cross-sectional diagrammatic representation of a second preferred embodiment of a block assembly according to the invention having a different arrangement of the internal channels of the base.

Before describing in detail one embodiment of the invention, it is important to specify that the invention is not limited to a particular type of pneumatic distributor. Although illustrated by pneumatic distributors of type 5/2, it can also be implemented with pneumatic distributors of different types, notably of type 3/2 or 4/2.

A pneumatic distributor 1 comprises a body having an air inlet 3, two exhaust outlets 4, 5 located on either side of the air inlet 3 and two control outlets 6, 7 each intended to be connected to a chamber of a dual-acting jack (not represented).

The body houses a sliding drawer 8 that can alternately switch from a position in which it ensures communication of the air inlet 3 with the control outlet 6 and communication between the control outlet 7 and the exhaust outlet 5, to a position in which it ensures communication of the air inlet 3 with the control outlet 7 and communication between the control outlet 6 and the exhaust outlet 4.

The sliding of the drawer 8 between these two positions is handled by a compressed air control 9 mounted against a return spring 10 tending to return the drawer to its initial position when the compressed air control 9 is not under pressure. Such a pneumatic distributor 1 is called monostable, because it has only one stable position. It is obviously possible to use bistable pneumatic distributors having two compressed air controls mounted one against the other.

It should be noted that, in order to allow the displacement of the drawer 8 and the compression and expansion of the spring 10, the spring is housed in a chamber in communication with atmospheric pressure or at a pressure less than the pressure of the compressed air control 9.

A functional diagram of the pneumatic distributor 1 is represented in FIG. 1.

The compressed air control 9 is controlled by a solenoid valve 12 respectively making it possible to control the pressurizing of the compressed air control 9 and release this pressure. Each solenoid valve 12 is fitted with a manual control 13 making it possible to force the drawer manually into a desired position, and an electrical control 14.

Although illustrated by pneumatic distributors 1 of monostable type 5/2, it is obviously possible to use bistable pneumatic distributors. In the event, the space provided for a second solenoid valve 12 is occupied by a dummy solenoid valve 12′ having a dummy manual control 13′.

The set of pneumatic distributors 1 intended to control a set of jacks is combined on a block assembly 15 of pneumatic distributors 1, a first preferred embodiment of which is represented in FIG. 2, in which the distributors are fixed using screws 60 cooperating with corresponding tapped holes. The example described proposes distributors that are easy to dismantle and replace. It is, however, quite obviously possible to directly incorporate these distributors in the block assembly 15.

The block assembly 15 of pneumatic distributors 1 comprises a body comprising a base 16 on which are added the pneumatic distributors 1 in pairs, each pair comprising a pneumatic distributor 1 attached adjacent to a second pneumatic distributor 1 on either side of a longitudinal central axis A. The pneumatic distributors 1 of each pair are symmetrically oriented relative to said longitudinal central axis A so that the solenoid valve 12 and the dummy solenoid valve 12′ of each pneumatic distributor 1 are respectively facing the dummy solenoid valve 12′ and the solenoid valve 12 of the corresponding pneumatic distributor 1. In this way, the solenoid valves 12 and the dummy solenoid valves 12′ are combined substantially in the middle of the base 16. The block assembly 15 represented in FIG. 2 comprises six pairs of pneumatic distributors 1.

The base 16 comprises a common compressed air supply 17, a common exhaust 18 and an auxiliary air supply 19 and an auxiliary exhaust 20 intended to supply and evacuate the air used by the solenoid valves 12 controlling the displacements of the drawers 8 of the pneumatic distributors 1.

More specifically, the base 16 is produced from modules 21 as represented in FIGS. 3 to 5, each intended to receive two pairs of pneumatic distributors 1. It is obviously possible to design modules intended to receive a single pair of pneumatic distributors 1, or more than two pairs, and to associate base modules intended for 5/2 pneumatic distributors with modules for 3/2 pneumatic distributors in order to combine them on one and the same block assembly 15.

Each module 21 is attached to the preceding module 21 by means of transversal screws (not visible) cooperating with corresponding tapped holes and the set of modules 21 is enclosed by a closure plate 52, from which open out the auxiliary supply duct 19 and the auxiliary exhaust duct 20.

Each module 21 of the base 16 comprises a bottom wall (not visible), a front wall 23 and rear wall 24, substantially parallel to the longitudinal central axis A, a top wall 25 intended to receive the pneumatic distributors 1, a front lateral wall 26 and a rear lateral wall (not visible) intended to be oriented towards a head module 53 of the block assembly. This top wall 25 is configured to present a groove 28 centered on the longitudinal central axis A and intended to receive the solenoid valves 12, 12′ of each pneumatic distributor 1.

Under the groove 28 is provided a central internal channel 32 passing through the module 21 to open out into the front wall 26 and into the rear wall so as to form with the central channels 32 of the preceding and following modules 21 a common central channel intended to receive an electrical control module for the solenoid valves 12.

For this, the top wall 25 has, in the groove 28, openings 33 opening out into the central channel 32 and making it possible to introduce the solenoid valves 12, 12′ so as to enable an electrical control unit 58 for each solenoid valve 12 to be connected to the electrical control module.

Each electrical control module can be connected to the preceding and following modules 21 to ultimately form a control bus that can be controlled using a common control interface 50.

The supply to the solenoid valves 12 under auxiliary pressure is handled via a channel 54 provided through each module 21 of the base 16 and connected to each solenoid valve, which, after connection of the modules 21, constitutes a supply duct under auxiliary pressure connected to the supply under auxiliary pressure 19.

The exhaust of the auxiliary pressure is obtained in the same way via a channel 55 connected to the exhaust under auxiliary pressure 20.

The supply and exhaust of each pneumatic distributor 1 are also handled according to the same principle.

For this, the module 21 has, on either side of the central internal channel 32, a supply channel 34 under pressure and an exhaust channel 35 situated between the supply channel 34 and the top wall 25.

The top wall 25 has, level with each pneumatic distributor 1, openings intended to ensure communication between the different channels of the base 16 and the circuits of the pneumatic distributor 1. Thus, an opening 40 is provided opposite each supply orifice of each distributor 1, this opening 40 being in communication with the supply channel 34 via a duct 41. Openings 42, 43 are provided opposite each exhaust orifice of each distributor 1, these openings 42, 43 being in communication with the exhaust channel 35.

Finally, openings 44, 45 are provided opposite each control orifice of each pneumatic distributor 1, each of these openings 44, 45 being in communication with a corresponding coupling 49 added to a lateral face of the module 21, via a dedicated transversal channel 46, 47.

As detailed previously, the example represented has a supply duct 54 and exhaust duct 55 under auxiliary pressure independent of the supply duct 34 and exhaust duct 35 of the pneumatic distributors 1. It is obviously possible to provide for the solenoid valves to be supplied with pressure via the supply duct under pressure 34 and for the exhaust to be handled via the exhaust duct 35.

However, the presence of an independent supply and exhaust circuit for the solenoid valves 12 makes it possible to operate the pneumatic distributors 1 at a desired pressure different from the operating pressure of the solenoid valves 12.

FIGS. 6 and 7 represent the different positions of a drawer 8 of a pneumatic distributor 1 and make it possible to illustrate the circulation of the air.

FIG. 6 represents the drawer 8 in the controlled position, whereas FIG. 7 represents it in its stable position.

In its stable position, the drawer 8 makes it possible to ensure direct communication between the air inlet 3 and the control outlet 4, whereas the control outlet 5 communicates with the exhaust 7.

In its controlled position, the drawer 8 makes it possible to ensure direct communication between the air inlet 3 and the control outlet 5, whereas the control outlet 4 communicates with the exhaust 6.

FIG. 8 represents an embodiment variant of the invention. A base according to FIG. 8 is differentiated from the base 16, only by the fact that it is produced from modules 121, the control couplings 49 of which are located on the bottom wall 22, the transversal channels 46, 47 being configured accordingly.

The presence of the couplings 49 on the bottom wall 22 makes it possible to place standard couplings 49, notably of G 1/8 type, the bottom surface 22 offering more space than the lateral wall to have this type of coupling.

FIG. 9 represents another embodiment variant of a module 221 differentiated from the modules 21, 121 by the fact that it comprises a single exhaust channel 135 serving the pneumatic distributors 1 on each side of the longitudinal central axis A, the mechanical resistance of the base level with the exhaust channel 135 being provided by spacers 136.

Other variants are also possible. It is possible to cite, for example, the fact of having only a single supply channel under pressure, or alternatively providing two supply channels each serving one side of the longitudinal central axis A, each supply channel being connected to a separate supply thus making it possible to combine on one and the same base pneumatic distributors 1 operating at different supply pressures.

Complementarily, the base 16 can be fitted with light guides, preferably produced in plastic material, arranged between each pair of pneumatic distributors 1 and intended to bring the light emitted by a diode fitted on the electrical control circuit and representing the position of the corresponding solenoid valve 12.

It is also worth noting that all the places provided on the base need not necessarily be occupied by pneumatic distributors 1. In the case where a user wants only an odd number of pneumatic distributors 1, for example, dummy distributors simply making it possible to block the openings can be installed on the base 16.

Although the invention has been described with particular embodiment examples, it is obvious that it is by no means limited thereto and that it comprises all the technical equivalents of the means described and their combinations provided that the latter fall within the framework of the invention.

1. A block assembly for pneumatic distributors comprising a base intended to receive a plurality of pneumatic distributors, possessing for this purpose at least one supply duct which can be connected to a supply inlet of each distributor and at least one exhaust duct which can be linked to each exhaust outlet of each distributor, and additionally having, for each control outlet of each distributor, at least one corresponding outlet channel intended to be connected to a pneumatic actuator, said base being designed such that the pneumatic distributors can be arranged on either side of a longitudinal central axis (A) of said base in at least two substantially parallel rows, characterized in that the base is also designed to equally receive pneumatic distributors of different types.

2. The block assembly for pneumatic distributors as claimed in claim 1, characterized in that the rows of distributors are substantially juxtaposed.

3. The block assembly for pneumatic distributors as claimed in claim 1, characterized in that the distributors can be arranged symmetrically relative to the longitudinal central axis (A).

4. The block assembly for pneumatic distributors as claimed in claim 3, characterized in that each pneumatic distributor comprises at least one actuation means which can be arranged facing an actuation means of the corresponding pneumatic distributor relative to the longitudinal central axis (A).

5. The block assembly for pneumatic distributors as claimed in claim 1, characterized in that each pneumatic distributor comprises at least one actuation means, and in that the base has at least one channel intended to receive at least one centralized means of electrically controlling the actuation means of at least one row of pneumatic distributors, of printed circuit type, said channel being able to allow a connection of the actuation means to the electrical control means.

6. The block assembly for pneumatic distributors as claimed in claim 5, characterized in that the base has a central channel intended to receive at least one centralized means of electrically controlling the actuation means of the pneumatic distributors.

7. The block assembly for pneumatic distributors as claimed in claim 1, characterized in that the base is designed to receive pneumatic distributors comprising pneumatic actuation means and comprises at least one auxiliary supply duct under pressure and at least one auxiliary exhaust duct which can be connected to the actuation means.

8. The block assembly for pneumatic distributors as claimed in claim 5, characterized in that the base is fitted with light guides opening onto a face of the latter and which can guide a light signal emitted by the control means and representative of the position of the actuation means of the pneumatic distributor.

9. The block assembly for pneumatic distributors as claimed in claim 1, characterized in that the outlet channels open out level with a front face or rear face of the base.

10. The block assembly for pneumatic distributors as claimed in claim 1, characterized in that the outlet channels open out level with a bottom face of the base.

11. The block assembly for pneumatic distributors as claimed in claim 1, characterized in that the base is designed to receive pneumatic distributors of type 5/2.

12. The block assembly for pneumatic distributors as claimed in claim 1, characterized in that the base is designed to receive distributors of type 3/2.

13. The block assembly for pneumatic distributors as claimed in claim 1, characterized in that the base is designed to receive distributors of type 4/2.

14. The block assembly for pneumatic distributors as claimed in claim 1, characterized in that the base is produced from modules, each intended to receive at least one pair of distributors.

15. An installation, characterized in that it comprises at least one block assembly as claimed in claim 1, in which are mounted the associated pneumatic distributors.
